(19) United States
(12) Patent Application Publication
(10) Pub. No.: US 2013/0217498 A1
(43) Pub. Date: Aug. 22, 2013

(54) GAME CONTROLLING METHOD FOR USE IN TOUCH PANEL MEDIUM AND GAME MEDIUM

(71) Applicant: Fourier Information Corp., (US)

(72) Inventor: YI-CHEN WANG, Taipei City (TW)

(73) Assignee: FOURIER INFORMATION CORP., Taipei City (TW)

(21) Appl. No.: 13/770,814

(22) Filed: Feb. 19, 2013

(30) Foreign Application Priority Data
Feb. 20, 2012 (TW) 101105438

(51) Int. Cl. A63F 13/06

(52) U.S. Cl. CPC A63F 13/06
USPC 463/37

(57) ABSTRACT

The present invention provides a game controlling method for use in a touch panel medium. The medium includes a touch panel device and a processor device. The game includes a controlled virtual object displayed on the touch panel device, and the processor device is loaded with different programs specifically corresponding to different numbers of the initial points of touch. Upon receiving a touch signal indicative of the number of the initial points of touch from the touch panel device, one of the programs specifically corresponding to the number of the initial points of touch is executed to make the controlled virtual object demonstrate a specific activity. At least one of the programs should make the controlled virtual object continue to demonstrate the activity for a predetermined period of time after the touch is released.

### FIELD OF THE INVENTION

This invention is a game controlling method and, more particularly, to a game controlling method for use in a touch panel medium.

### DESCRIPTION OF THE RELATED ART

With the great advancement of touch sensing technology in recent years, plus the great convenience of its applications, various touch sensing technologies are widely applied in different electronics, among which the touch panel is being gradually applied in cellular phones or computers, such as iPhone® and iPad®, because of its advantages of being small in size, low in cost, low in power consumption, and long service life. Put it simply, the touch panel is a display device that can receive the input signal of a touch (finger or stylus). When touching the graphic buttons displayed on the screen, the tactile feedback system on the screen will start up various connected devices based on the preprogrammed applications, and produce lively visual and audio effects on the display screen.

Take the First-Person Shooter Game (FPS) played on the computer as an example. Generally, when playing FPS on a computer, most players control the character to dodge the bullets by pressing the keyboard with the left hand, while using the right hand to move the cursor to change visual angles so as to search and attack the enemy. However, the situation will be different when the computer game is transferred onto an electronic device with touch panel as the interface. As shown in FIG. 1, in the FPS gaming process, players are required to control the character and change visual angles to search the enemy at the same time, which makes it difficult to transfer the FPS onto the touch panel. Moreover, due to the touch interface of the iOS, it becomes even more difficult to play this kind of game. For the barely transferred games, the moving control button 81 is displayed on the lower left of the touch panel 8, while the visual angle controlling button 82 is displayed on the lower right. For counter-strike, players should change the visual angle until the virtual enemy enters the shooting area in the center of the screen, then aim the target and press the visual angle controlling button 82 to shoot towards the central position of the screen.

Due to the design of virtual buttons, players have to hold the touch panel to control the character with both hands. However, Smartphone users must hold the phone with one hand while controlling by touch with the other hand; or they hold the phone with four fingers of both hands, while leaving the thumbs to touch the screen. If this case is further expanded to the tablet PC, it will be more difficult to leave the thumbs for the touching function, because the tablet PC is too large to hold using just the four fingers of both hands and the device may be easily dropped. Therefore, when playing games, it should consider fixing the tablet PC by one hand as shown in FIG. 2, so as to spare the other hand to operate the tablet PC. Moreover, virtual buttons also take up a part of the screen affecting the game display and making the visual area of the game screen smaller.

With the intuitive operational feature, various touch games have been developed on either the Smartphone or the tablet PC. However, restricted by the above touch devices, it decreases the operational accuracy of the player, making the game interface unfriendly to the player. Meanwhile, the player cannot thoroughly enjoy the game due to the limitation of operability, reducing the playability of the game. Therefore, there is a need for a game controlling method that allows using one hand for touching the panel and using the other hand for holding the panel, so as to provide greater operability of the touch control games and allow multiple complicated commands, thus greatly improving the control convenience for players.

### SUMMARY OF THE INVENTION

In response to the need, the invention provides a game controlling method, which is adapted to detect and identify the initial point(s) of a touch and sense the subsequent motion of the touch, and temporarily continue to demonstrate the activity resulted from the touch for a predetermined period of time. The invention allows the developers of touch panel games to design games that are easier-to-operate and friendlier to the players, so that the games can be readily played by inexperienced game players. The invention also increases the versatility of the game by allowing multiple complicated commands, which further improves the playability of the game. The game controlling method disclosed herein can resolve the aforementioned problems encountered by the game medium on the touch panel.

The first object of this invention is to provide a game controlling method for use in a touch panel medium which can be operated with a single hand, so as to improve the convenience of game operations.

The second object of this invention is to provide a game controlling method with a prolonged command for use in a touch panel medium, which realizes the synchronous execution of a prolonged command and a non-prolonged command, thereby increasing the delicacy of the game.

The third object of this invention is to provide a game controlling method for use in a touch panel medium without using any virtual buttons, thereby maximizing the visual area of the panel.

The fourth object of this invention is to provide a game medium that can be easily controlled with one hand, giving the player added convenience.

The fifth object of this invention is to provide a gaming medium without using any virtual button, thereby maximizing the visual area of the touch panel.

This invention provides a game controlling method for use in a touch panel medium comprising of a touch panel device and a processor device, wherein the game includes at least one controlled virtual object displayed on the touch panel device, and the processor device is loaded with different programs specifically corresponding to different numbers of the initial points of touch. Upon receiving a touch signal indicative of the number of the initial points of touch from the touch panel device, one of the programs specifically corresponding to the number of the initial points of touch is executed to make at least one controlled virtual object demonstrate a specific activity. The method includes the following steps: a) identifying the number of the initial points of the touch and executing a program corresponding to the number of the initial points of the touch; b) sensing the subsequent motion of the touch; and c) making at least one controlled virtual object demonstrate an activity in accordance with the executed program and the subsequent motion of the touch. At least one of the programs should at least make one controlled virtual object continue to demonstrate the activity for a predetermined period of time after the touch is released.

According to the technical features disclosed herein, through the function of recording the game motions, the invention can continue to demonstrate the activity for a predetermined period of time after the touch is released, and it executes the designated programs corresponding to the changes in finger touch on the touch screen. By doing so, it allows controlling complicated commands by one hand easily, so as to improve the convenience of the game operations, keep the fun in gaming, and further facilitate the game designer to develop more highly operational games.

### BRIEF DESCRIPTION OF THE DRAWINGS

The above and other objects, features and effects of the invention will become apparent with reference to the following description of the preferred embodiments taken in conjunction with the accompanying drawings, in which:

FIG. 1 is a schematic diagram of a conventional FPS scenario displayed on the touch panel;

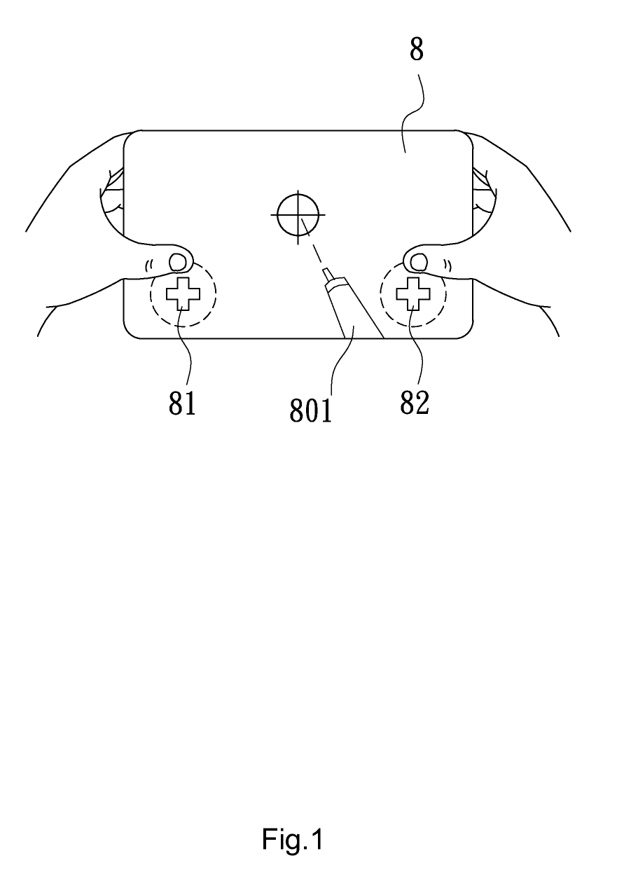

FIG. 2 is a diagram showing a conventional touch controlling of a tablet PC;

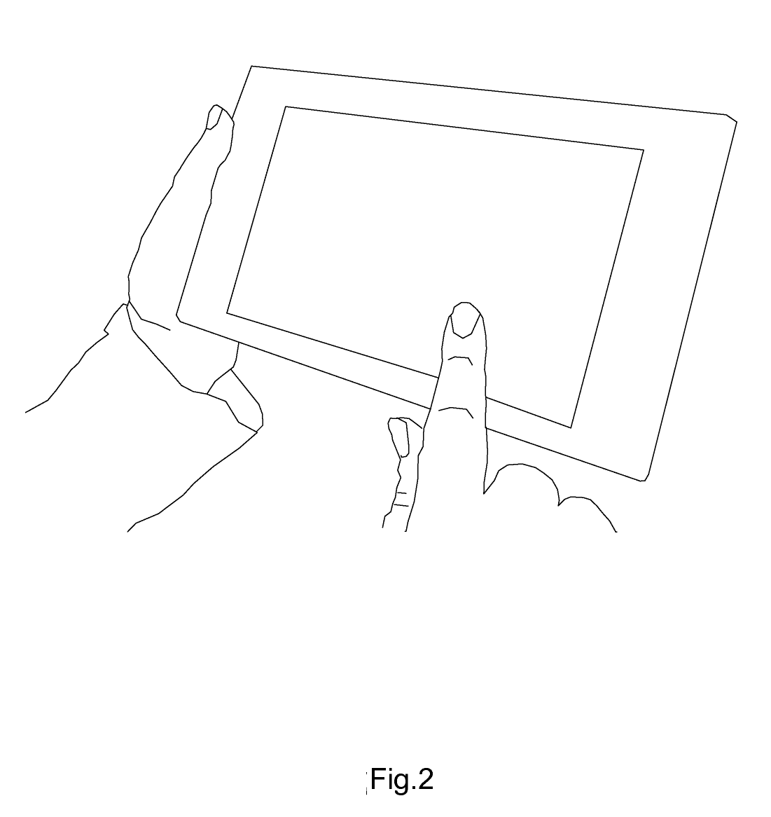

FIG. 3 is a block diagram of the touch panel medium according to the invention;

FIG. 4 is a schematic diagram of an FPS scenario according to the invention;

FIGS. 5-6 are schematic diagrams of conventional FPS gaming scenarios;

FIGS. 7-8 are schematic diagrams of gaming scenarios for the game shown in FIG. 4; and

FIGS. 9-11 are schematic diagrams of gaming scenarios of a racing game according to the invention.

### DETAILED DESCRIPTION OF THE INVENTION

The foregoing and other features and advantages of the invention may be more completely understood in consideration of the following detailed description of various embodiments of the invention in connection with the accompanying drawings, wherein similar numerals designate like parts.

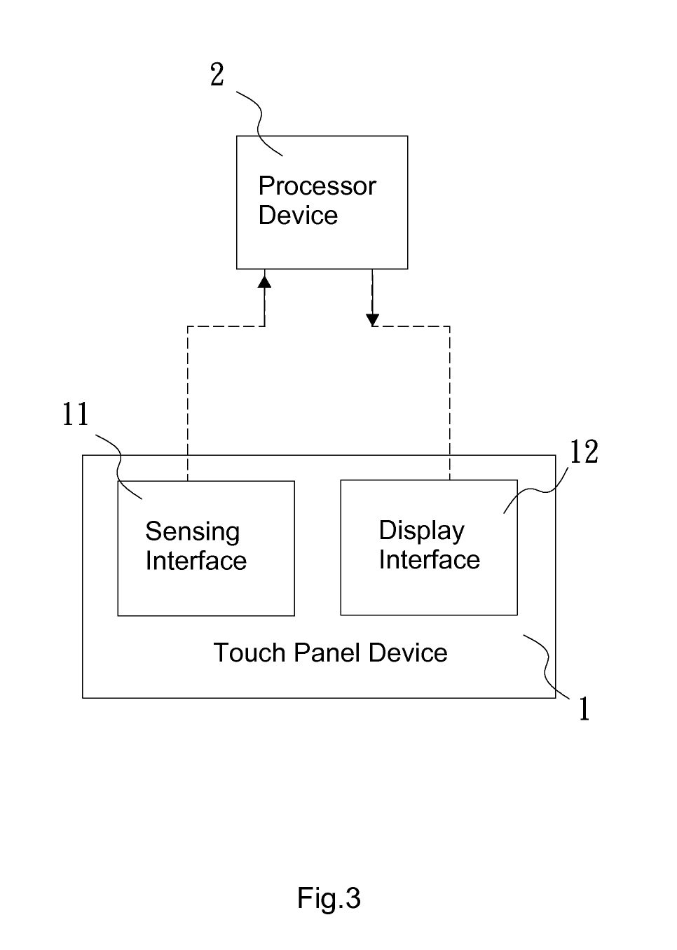

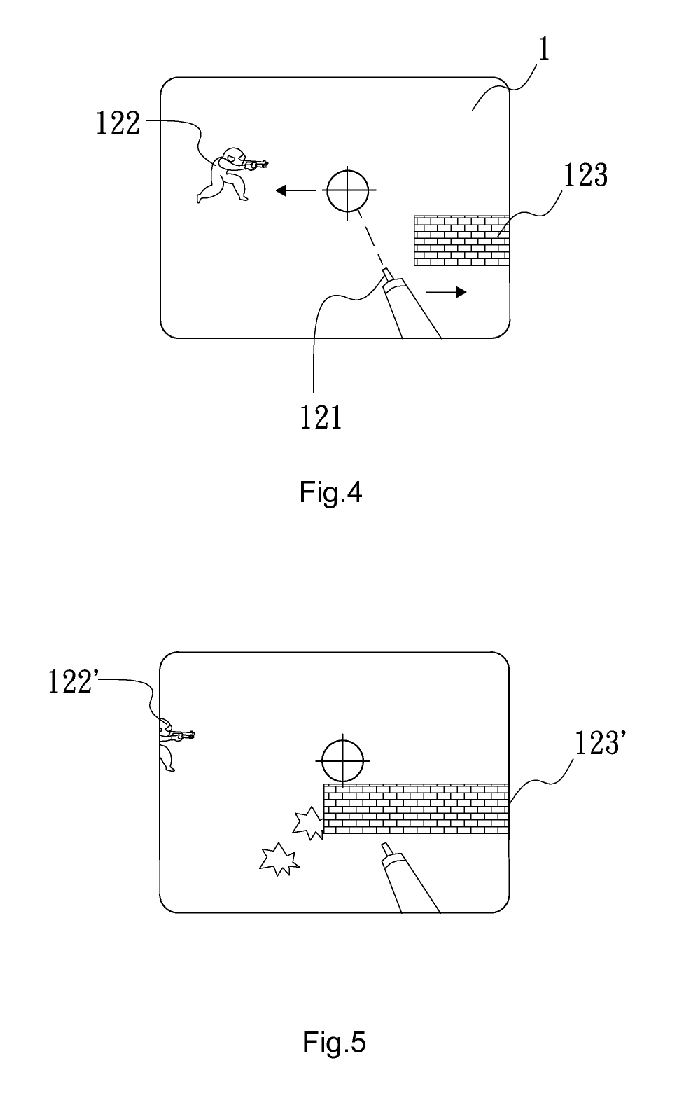

As shown in FIG. 3, the touch panel game medium used in the invented game controlling method comprises a conventional touch panel device 1 and a processor device 2 that is equipped inside of the touch panel device 1. The touch panel device 1 comprises a sensing interface 11 and a display interface 12 overlapped with the sensing interface 11. The display interface 12 has multiple pixels to make up images on the screen. The sensing interface 11 is transparent and disposed on the display interface 12, which is provided with a plurality of sensing cells adapted to detect and identify the number of finger touches or the state and speed of finger motions on the touch panel device 1, and then transmit the relevant data to processor device 2. The processor device 2 will display images on the display interface 12 as shown in FIG. 4 in accordance with the executed program, and based on the sensing result obtained by sensing interface 11, so as to make a controlled virtual object 121 to demonstrate a certain activity, such as to change the motion of the controlled virtual object 121.

FIG. 4 shows an example of applying the invention on an FPS. In this example, the controlled virtual object 121 is the gun muzzle position of the virtual fighter on our side. As stated above, the operation command at least includes the following three commands: moving, horizontally rotating the pointing direction of the gun muzzle, and shooting. Therefore, as shown in the figure, when the touch panel device 1 displays a virtual enemy fighter 122 approaching from the upper left, and a virtual low wall 123 on the upper right can provide cover, the professional player will choose to move the character towards the right, so as to hide most of the body behind the virtual low wall 123. At the same time, he will turn the gun muzzle counter-clockwise, exposing the enemy under the gun. Finally the player will aim at the target and shoot.

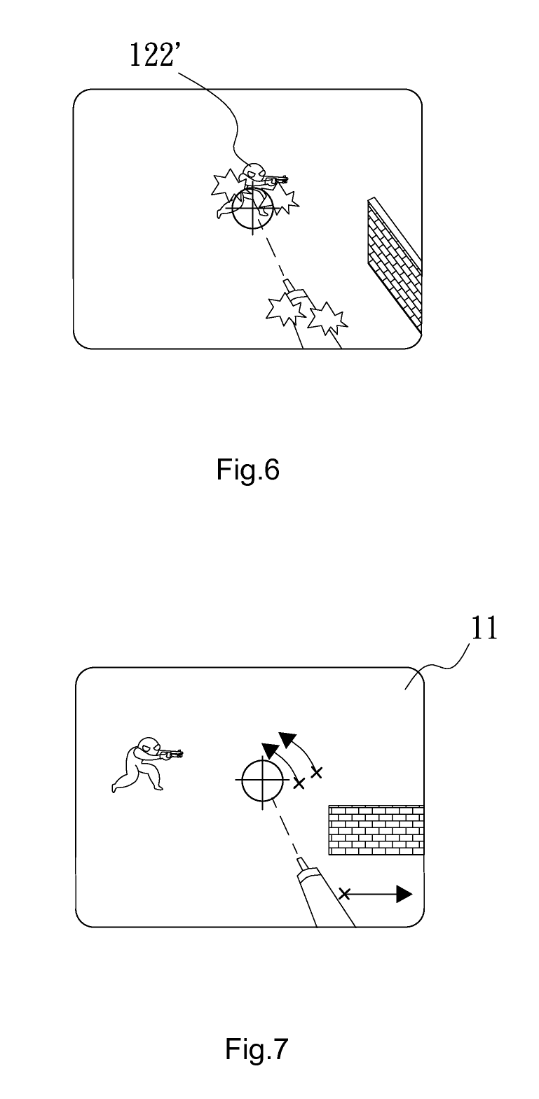

However, when using the conventional operational interface of the touch panel game medium, the game player may have to hold the game medium with one hand. Thus, with only one hand controlling the game, when the player moves the virtual character on our side, as shown in FIG. 5, he/she will not be able to turn the gun muzzle's direction. As a result, although the virtual character on our side hides behind the virtual low wall 123′, the player is unable to aim at the virtual enemy fighter 122′. On the contrary, if the player chooses to turn the gun muzzle's direction, as shown in FIG. 6, the character on our side could shoot the virtual enemy fighter 122′, but at the same time, the character will be exposed under the enemy's gun and shot to die together with the enemy. Especially when the player is too intense on the game, the finger touch is out of the range of the virtual buttons on the screen, the processor device won't respond to this kind of operation. In this case, the player may feel helpless.

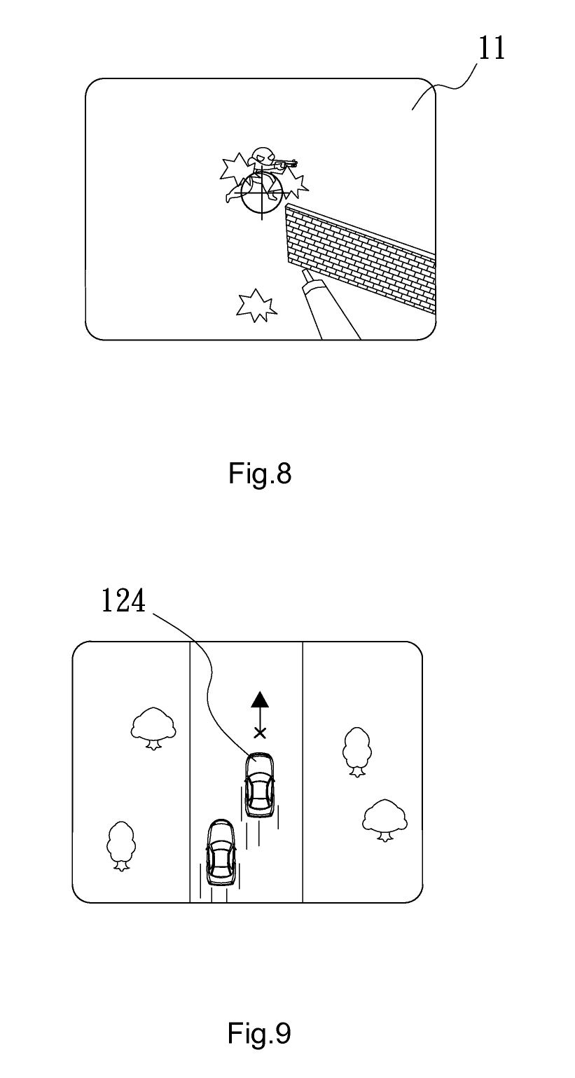

In contrast, the gaming controlling method disclosed herein, as shown in FIG. 7, can pre-define a single-finger moving operation as a command of moving the character, which is inertia responsive as default, a dual-finger moving operation as a command of turning the gun, and a dual-finger tapping operation as a command of shooting. In this way, different programs may be executed in responsive to the command, so as to change the motion of the virtual character on our side. Therefore, the player's right index finger can first slide towards the right direction on the sensing interface 11 (represented by a single cross), sending the command to the processor device to shift screen in accordance with the correspondent movement direction of the virtual character on our side towards the right; and then the player's right index finger and middle finger may slide along the counter-clockwise direction on the sensing interface 11 (represented by two crosses), sending the command to the processor device to change screen in accordance with the correspondent rotation direction of the visual angle and gun of the virtual character on our side.

With the design of inertial response, after the player switches from the single-finger operation to the dual-finger operation, the moving command will continue to demonstrate the moving activity for a period of time until it is attenuated to a preset threshold level (e.g., a period of 5 seconds), making the virtual character on our side hide behind the low wall. As shown in FIG. 8, during the period of 5 seconds when the virtual character on our side is continuously moving, the player could readily switch to the dual-finger operation to turn the gun muzzle's direction, and finger-tap the sensing interface 11 to shoot the enemy, so as to accomplish the mission in the game. On the other hand, the player could change the distance and duration of a touch operation, so as to change the motion of the controlled virtual object. For example, the player may first finger-tap on the position of an enemy for a second, allowing the fighter's gun to accumulate energy. When the player taps on the panel for a second time, it will initiate shooting and attack the enemy with a more powerful energy wave.

It is apparent to those skilled in the art that the commands in the game are not limited to those described above and may comprise, for example, using a three-finger operation as a command of switching the weapon from one to another. Since the embodiment above doesn't have to display virtual buttons, such as a virtual joystick, on the display interface, it can fully display the image of the game on the display interface.

Through the default processing program, it will take the virtual motions corresponding to different numbers of touch point(s) and various changes in touch state. Therefore, the operation disclosed herein is easier than conventional operations and simply requires changing touch points and touch state to accurately control the motions of the virtual character, such as moving, changing visual angles, attacking the enemy, and switching weapons. It doesn't need to keep one eye on many things, so the player won't be in a hurry-scurry state. In this way, it reduces the operational complexity of the game.

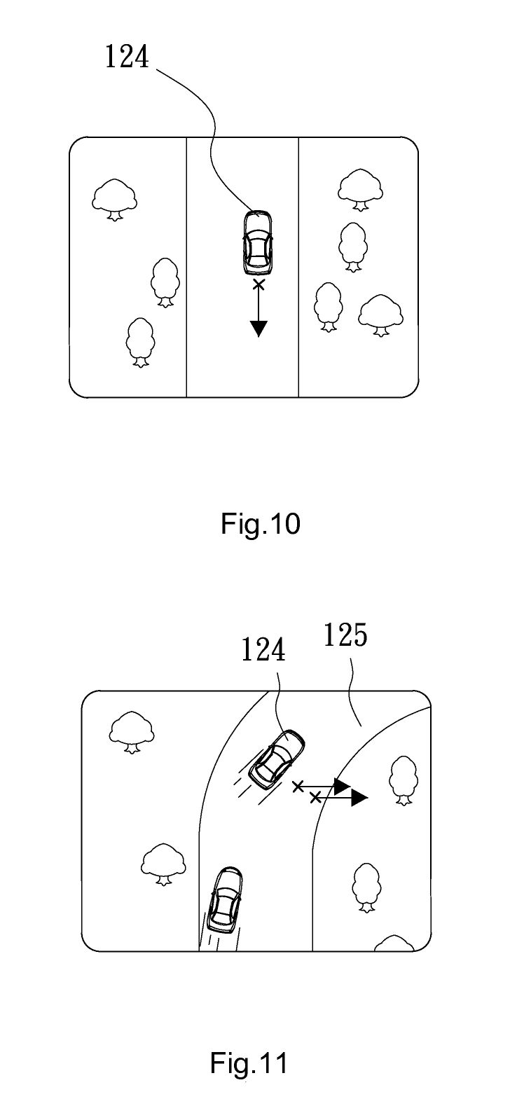

FIG. 9 is an example of applying the invention in a racing game. In this example, the controlled virtual object is the virtual racing car on our side 124. In the operational interface of the conventional racing game machine, it is like actual driving. The player is required to sit on the seat of the machine, adjust speed file location with hands or feet, or put on the gas or brake pedal to accelerate or decelerate the car, and control the direction or make sharp turns or motion by the direction buttons or the direction plate. When transferring this kind of game on a touch panel medium, it often requires setting up virtual control buttons on both sides of the panel like the above structure, which also has the shortcomings as mentioned above. In contrast, by applying the game controlling method disclosed herein, it could pre-define the single-finger moving motion as a command of controlling the acceleration or deceleration of the virtual racing car on our side 124 in the program. Moreover, it could be set as inertial response by default, and a dual-finger operation could be set to control the turning of the front wheels. Therefore, the player could control it with one hand easily.

When the race begins, the player's index finger on the right hand may first slide along the arrow direction to the upper side of the screen on the sensing interface. This will generate a speed acceleration corresponding to the finger sliding distance. The acceleration of the virtual car is with the inertial response design. When the index finger slides 2 cm upwards, the racing car will be started and accelerated to 160 km/h, and stay at that speed without continuously pressing the speed button. When the player wants to accelerate as shown in FIG. 9, he just needs to lightly touch the sensing interface by the index finger, and move 0.5 cm upward, which will then accelerate the car on our side to 200 km/h. The design of the game may make the car stay at that speed. When the player wants to decelerate as shown in FIG. 10, he only needs to touch the sensing interface by the index finger, and move about 1.5 cm downwards, which will then decelerate the car on our side to 80 km/h. Through the sliding distance of the touch, the player could control the acceleration or deceleration, so as to control the speed of the car accurately.

As for the driving direction, it currently makes use of the electronic gyroscope built in a smart phone or a tablet PC, making the game player directly control the driving direction by adjusting the relative heights of both sides of the smart phone or PC. In this example, when the virtual hairpin turn 125 is shown on the racetrack as shown in FIG. 11, in which the player cannot control the direction merely by tilting the game medium to turn the front-wheels, he could use the index finger and middle finger on the right hand to slide along the arrow direction to the right. By doing so, it could activate the braking command on the virtual racing car on our side 124 quickly, and generate the feint motion under the sharp turn, so as to change the driving direction at high speed and move corresponding to the turning direction.

To sum up, the game controlling method disclosed herein provides different operation modes responsive to different numbers of touch points and touch motions, and even provides inertial response under at least one operation mode. As a result, the player doesn't have to concern about the state of each operation command at all times. On one hand, it makes the game more user-friendly and easy-to-play. On the other hand, it provides the inertial response motion for complicated games. It means the player doesn't necessarily perform every action by himself, but leave some commands to be executed by the processor device. In this way, the player could focus on the command control in other aspects, so as to lower the complexity of the game. The invention goes out of the boundary of the virtual buttons, thus facilitating the use of the medium space and expanding the visual area of the screen. The invention is also applicable to laptop computers, smart phones, portable game stations and so on.

While the invention has been described with reference to the preferred embodiments above, it should be recognized that the preferred embodiments are given for the purpose of illustration only and are not intended to limit the scope of the present invention and that various modifications and changes, which will be apparent to those skilled in the relevant art, may be made without departing from the spirit and scope of the invention.

What is claimed is:

1. A game controlling method for use in a touch panel medium comprising a touch panel device provided with a plurality of cells and a processor device, wherein the touch panel device is adapted to detect and identify a number of one or more initial points of a touch and sensing the subsequent motion of the touch; and wherein the game includes at least one controlled virtual object displayed on the touch panel device, and the method comprising the steps of:
identifying the number of the initial points of the touch and executing a program corresponding to the number of the initial points of the touch;
sensing the subsequent motion of the touch; and
upon the processor receiving a touch signal from the touch panel device, making the at least one controlled virtual object demonstrate an activity in accordance with the executed program and the subsequent motion of the touch, wherein at least one of the programs makes the at least one controlled virtual object continue to demonstrate the activity for a predetermined period of time after the touch is released.

2. The game controlling method according to claim 1, wherein the step b) further comprises a sub-step b1) of identifying a direction of the subsequent motion of the touch.

3. The game controlling method according to claim 1, wherein the step b) further comprises a sub-step b2) of identifying a moving distance of the subsequent motion of the touch.

4. The game controlling method according to claim 3, wherein the step b) further comprises a sub-step b3) of identifying a duration of the subsequent motion of the touch.

5. The game controlling method according to claim 1, wherein the step c) further comprises the sub-steps of:
c1) modifying the activity of the at least one controlled virtual object in accordance with a direction, a speed of the subsequent motion of the touch and/or the executed program; and
c2) temporarily continuing the activity and then attenuating the activity over time until the activity is attenuated to a predetermined threshold level.

6. The game controlling method according to claim 5, wherein the at least one controlled virtual object is a virtual item, and wherein the program of continuing to demonstrate the activity for a predetermined period of time in the step c) corresponds to the program of making the virtual item demonstrate the activity.

7. A game medium comprising a touch panel and adapted to execute at least one game including at least one controlled virtual object displayed on the game medium, the game medium comprising:
a touch panel device adapted to detect and identify a number of one or more initial points of a touch and sensing the subsequent motion of the touch; and
a processor device loaded with different programs specifically corresponding to different numbers of the initial points of touch, and adapted to execute one of the programs specifically corresponding to the number of the initial points of touch to make the at least one controlled virtual object demonstrate a specific activity upon receiving a touch signal indicative of the number of the initial points of touch from the touch panel device, and adapted to allow the executed program to continuously execute for a predetermined period of time after the touch is released.

8. The game medium according to claim 7, wherein the touch panel device further comprises:
a sensing interface for detecting and identifying the touch; and
a display interface for displaying images.

9. The game medium according to claim 7, wherein the at least one controlled virtual object is a virtual item, and wherein the program of continuing to demonstrate the activity for a predetermined period of time corresponds to the program of making the virtual item demonstrate the activity.
